(19) United States
(12) Patent Application Publication
(10) Pub. No.: US 2023/0159847 A1
(43) Pub. Date: May 25, 2023

(54) ELECTROVISCOUS FLUID AND CYLINDER DEVICE

(71) Applicant: Hitachi Astemo, Ltd., Hitachinaka-shi, Ibaraki (JP)

(72) Inventors: Satoshi ISHII, Tokyo (JP); Hitomi TAKAHASHI, Tokyo (JP)

(73) Assignee: Hitachi Astemo, Ltd., Hitachinaka-shi, Ibaraki (JP)

(21) Appl. No.: 17/919,765

(22) PCT Filed: May 6, 2021
(86) PCT No.: PCT/JP2021/017373

§ 371 Date: Oct. 19, 2022

(30) Foreign Application Priority Data
Jun. 5, 2020 (JP) 2020-098440

(51) Int. Cl. C10M 149/14; C08G 18/08; C08G 18/20; C08G 18/76; C08G 18/48; C08G 18/32; C08G 18/66; C10M 169/04; C10M 107/50; F16F 9/53; F16F 9/18

(52) U.S. Cl. CPC C10M 149/14; C08G 18/0871; C08G 18/2063; C08G 18/7614; C08G 18/7671; C08G 18/4845; C08G 18/3206; C08G 18/6674; C08G 18/3215; C08G 18/3212; C08G 18/3228; C08G 18/6685; C10M 169/041; C10M 107/50; F16F 9/532; F16F 9/185; C10M 2229/0415; C10M 2217/045; C10N 2030/60

(57) ABSTRACT

Provided are an electroviscous fluid exhibiting a high ER effect and having sufficient durability, and a cylinder device. An electroviscous fluid of the present invention includes a fluid and polyurethane particles containing metal ions. The polyurethane particles have a phase separation structure of a hard segment and a soft segment, and contain an additive increasing a urethane bond forming the hard segment.

### TECHNICAL FIELD

The present invention relates to an electroviscous fluid and a cylinder device.

### BACKGROUND ART

In general, a cylinder device is mounted on a vehicle in order to attenuate vibration during traveling in a short time to improve ride comfort and traveling stability. As one of such cylinder devices, a shock absorber is known. The shock absorber uses an electroviscous fluid (electro-rheological fluid (ERF)) in order to control a damping force according to a road surface condition or the like. In the cylinder device described above, an ERF containing particles (particle dispersion system ERF) is generally used, but the material and shape of the particles are known to affect the performance of the ERF and thus the performance of the cylinder device.

As a technique related to the ERF, for example, PTL 1 discloses an ERF in which polyurethane particles containing one or a plurality of electrolytes are dispersed in a silicone oil. In the ERF, main components constituting polyurethane are polyether polyol and toluene diisocyanate (TDI), and an electrolyte contained in the polyurethane particles is an organic anion such as an acetate ion or a stearate ion, and substantially contains no inorganic metal anion.

PTL 2 discloses that a homogeneous ERF which is an ERF containing no particles is designed such that thermoplastic polyurethane molecules are contained and the polyurethane molecules cause phase separation between a soft segment and a hard segment, whereby urethane bonds forming the hard segment is likely to form an aggregate when a voltage is applied, which makes it possible to improve an ER effect.

### CITATION LIST

### Patent Literature

PTL 1: JP 2015-511643 A
PTL 2: JP 08-73877 A

### SUMMARY OF INVENTION

### Technical Problem

In the case of the particle dispersion system ERF described above, the viscosity change (ER effect) of the ERF due to voltage application is known to be affected by the magnitude of the dielectric constant of the contained particles. There are particles having a large dielectric constant, such as titanium oxide-based particles, which are expected. However, wear may occur due to the contact of hard particles with a liquid contact part in a component, and thus caution is required for the application of the particle dispersion system ERF. That is, it is desired to exhibit a sufficient ER effect using flexible resin particles, but the dielectric constant of the resin particles is lower than that of oxide-based particles, which requires breakthrough.

In the ERF to which the polyurethane particles containing the electrolyte described in PTL 1 are applied, ions are conducted in the polyurethane, so that the ions are unevenly distributed in the particles, and the polarization of the polyurethane particles is larger than the dielectric constant of only the resin. Thereby, the ER effect can be increased.

At this time, the conductivity of the ions in the particles (ionized ions of the electrolyte) in the polyurethane is important. Specifically, the higher the ionic conductivity of the polyurethane is, the higher the ER effect is. In general, the mobility of a polymer chain is involved in the ion conduction of a polymer such as polyurethane, and the higher the mobility is, the higher the ion conductivity is. As the physical properties of the polymer, a glass transition point (T_{g}) can be used as an index, and the lower the T_{g} is, the higher the ionic conductivity is.

However, when the T_{g} of the polymer is lowered to improve the ion conductivity, there may be a trade-off with physical properties related to durability such as mechanical strength and heat resistance.

Therefore, if polyurethane particles having both high T_{g} and high ionic conductivity are achieved by utilizing the phase separation structure of polyurethane as in PTL 2, an ERF having durability that can withstand practical use while exhibiting a high ER effect is considered to be able to be achieved. However, the homogeneous ERF used in PTL 2 has a smaller ER effect than that of a particle dispersion system. The polyurethane contained in the ERF is a thermoplastic resin, has low mechanical strength and heat resistance characteristics, and is a liquid. The polyurethane cannot be directly applied to the particle dispersion system, and thus is insufficient for use in a vehicle as in the present invention.

In view of the above circumstances, an object of the present invention is to provide an electroviscous fluid having sufficient durability (mechanical strength and heat resistance and the like) while exhibiting a large ER effect, and a cylinder device.

### Solution to Problem

One aspect of the present invention for achieving the above object is an electroviscous fluid containing: a fluid; and polyurethane particles containing metal ions, wherein the polyurethane particles have a phase separation structure of a hard segment and a soft segment, and contain an additive increasing a urethane bond forming the hard segment.

Another aspect of the present invention for achieving the above object is a cylinder device including: a piston rod; an inner cylinder into which the piston rod is inserted; and an electroviscous fluid provided between the piston rod and the inner cylinder, wherein the electroviscous fluid is the electroviscous fluid of the present invention described above.

A more specific configuration of the present invention is described in the claims.

### Advantageous Effects of Invention

The present invention can provide an electroviscous fluid having sufficient durability (mechanical strength and heat resistance and the like) while exhibiting a large ER effect, and a cylinder device.

Other problems, configurations, and advantages than described above will become apparent from the following description of embodiments.

### BRIEF DESCRIPTION OF DRAWINGS

FIG. 1 is a schematic diagram showing an example of an electroviscous fluid of the present invention.

FIG. 2 is a schematic view showing the configuration of polyurethane particles in FIG. 1.

FIG. 3 is a graph showing the relationship between the yield stress of each of ERFs of Example 2, Example 3, and Comparative Example (Ref) and a temperature.

FIG. 4 is a graph showing the maximum yield stress of each of ERFs of Example 2, Example 3, and Comparative Example.

FIG. 5 is a graph showing the yield stress of each of ERFs of Example 2, Example 4, Example 5, and Comparative Example (Ref).

FIG. 6 is a schematic longitudinal cross-sectional view showing an example of a cylinder device of the present invention.

### DESCRIPTION OF EMBODIMENTS

Hereinafter, embodiments of the present invention will be described in detail with reference to the drawings.

[Electroviscous Fluid]

FIG. 1 is a schematic diagram showing an example of an electroviscous fluid of the present invention. As shown in FIG. 1, an electroviscous fluid (hereinafter, referred to as “ERF”) 300 of the present invention contains a fluid 30 and polyurethane particles 31 containing metal ions. The fluid 30 is a dispersion medium composed of an insulating medium (base oil), and the polyurethane particles 31 are a dispersed phase dispersed in the base oil.

That is, a suspension in which the polyurethane particles 31 are dispersed in the base oil is the ERF. The polyurethane particles 31 containing metal ions are a substance that forms a particle structure between electrodes by the application of a voltage to exhibit an ER effect of increasing the viscosity of a fluid. The ER effect varies depending on the presence or absence and type of metal ions contained therein.

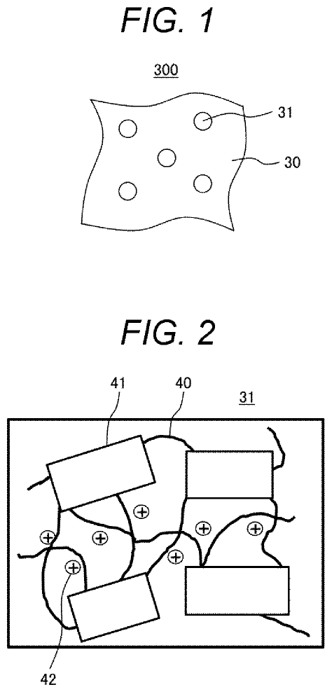

FIG. 2 is a schematic view showing the configuration of polyurethane particles in FIG. 1. As shown in FIG. 2, the polyurethane particles 31 have a phase separation structure of a soft segment 40 of a high molecular weight polyol and a hard segment 41 having a high urethane group concentration. The phase separation of polymers means that polymers of the same or different types incompatible with each other are in a separated state when copolymerized or blended. The soft segment 40 contributes to conduction of ions in the particles by performing larger molecular motion due to heat, and the hard segment 41 contributes to durability such as heat resistance and toughness of the particles. That is, the ER effect is affected by the material composition of the soft segment, and mechanical strength and heat resistance are affected by the material composition of the hard segment 41. Furthermore, these characteristics are mainly affected by the ratio of the soft segment 40 and the hard segment 41 and the degree of phase separation between the soft segment 40 and the hard segment 41.

As described above, by optimizing the material compositions of the soft segment 40 and the hard segment 41 and the ratio thereof in the particles, and improving the degree of phase separation, high ion conductivity and high T_{g} of the particles can be achieved, whereby an ERF having excellent durability (mechanical strength and heat resistance) while exhibiting a large ER effect can be achieved.

The polyurethane particles 31 contain a main component (high molecular weight polyol) and a curing agent (isocyanate), and further contain a chain extender that forms a hard segment to promote phase separation as a third component. A crosslinking agent may be further contained as the third component. The polyurethane particles are preferably made of a thermosetting resin from the viewpoint of improving durability.

The present inventors have intensively studied the composition of the polyurethane particles 31 in order to improve the ER effect of the electroviscous fluid. As a result, in order to improve the degree of phase separation between the soft segment 40 and the hard segment 41 in the polyurethane particles 31, the present inventors have considered that it is effective to increase a urethane bond in the hard segment 41 to more clearly aggregate and separate polyurethane chains contained in the hard segment 41. In order to achieve this, in the ERF of the present invention, a constituent component of the hard segment 41 contains a chain extender of the polyurethane chain as an additive. As described above, the use of the chain extender as the third component that forms the hard segment 41 of polyurethane makes it possible to obtain an ERF having sufficient durability (mechanical strength, heat resistance) while exhibiting a large ER effect.

The soft segment 40 and the hard segment 41 in the polyurethane particles 31 can be detected by performing processing such as binarization on an image obtained by imaging a difference in viscoelasticity of a particle cross section in measurement of the cross section of the polyurethane particles by a phase mode of atomic force microscopy (AFM).

The chain extender is preferably a monomolecular polyfunctional alcohol or polyfunctional amine. Examples of the polyfunctional alcohol include 1,3-propanediol, 1,4-butanediol, 1,5-pentanediol, 1,6-hexanediol, 1,7-heptanediol, 1,8-octanediol, 1,9-nonanediol, 1,4-cyclohexamethylenedimethanol, hydroquinone di(2-hydroxyethyl ether), glycerin, 1,1,1-trimethylolpropane, 1,2,4-butanetriol, 1,2,5-pentanetriol, 1,2,6-hexanetriol, 1,1,3,3-propanetetetraol, 1,2,3,4-butanetetraol, 1,1,5,5-pentanetetraol, and 1,2,3,5-pentanetetraol.

Examples of the monomolecular polyfunctional amine include 1,3-propanediamine, 1,4-butanediamine, 1,5-pentanediamine, 1,6-hexanediamine, 1,7-heptanediamine, 1,8-octanediamine, 1,9-nonanediamine, dimethylthiotoluenediamine, 4,4-methylenebis-o-chloroaniline, isophoronediamine, piperazine, 1,2,3-triamine, 1,2,4-butanetriamine, 1,2,5-pentanetriamine, 1,2,6-hexanetriamine, 1,1,3,3-propanetetraamine, 1,2,3,4-butanetetraamine, 1,1,5,5-pentanetetraamine, and 1,2,3,5-pentanetetraamine.

The chain extender is not limited to one type, and two or more types of chain extenders may be used in combination. For example, a bifunctional chain extender and a tri- or higher functional chain extender may be used in combination. The chain extender is not limited to the polyfunctional alcohol and the polyfunctional amine described above, and other substances can also be used as long as the substances can improve the degree of phase separation between the soft segment and the hard segment.

Among the chain extenders described above, 1,4-butanediol, 1,5-pentanediol, and 1,6-hexanediol are more preferable from the viewpoint of high versatility, a low melting point, and a simple process.

When a chain extender having an aliphatic skeleton is used, the number of carbon atoms is preferably an even number rather than an odd number. This is considered to be because when the number of carbon atoms is an even number, the interaction between polymer chains is strong, to cause the polymer chains to be densely aggregated in the hard segment, so that even when the polymer chains are introduced into a polyurethane skeleton, the influence of the interaction is advantageous for the phase separation between the soft segment and the hard segment. In particular, in consideration of the melting point, 1,4-butanediol having 4 carbon atoms and 1,6-hexanediol having 6 carbon atoms are more preferable.

In particular, 1,4-butanediol has a melting point of 20° C., is a liquid at normal temperature, and does not require equipment or a process for heating and melting in manufacturing, which is preferable. In that case, in order to remarkably cause the phase separation, a hydroxyl group equivalent ratio between a polyol and 1,4 butanediol (1,4-butanediol/polyol) is preferably 0.11 or more.

Examples of a material which can be used as a polyol that is a main agent (main component) constituting the polyurethane particles 31 include a polyether-based polyol, a polyester-based polyol, a polycarbonate-based polyol, a vegetable oil-based polyol, and a castor oil-based polyol. Even a polyol other than those listed above can be used in the present invention as long as it is a material capable of forming a polyurethane having an increased degree of phase separation together with a chain extender.

In particular, a repeating unit forming a polymer is preferably a polyol having 3 or less carbon atoms, and is preferably a trifunctional polyol having three hydroxyl groups. These are considered to three-dimensionally form a network structure to improve the durability of the ERF. In consideration of the ionic conductivity of the polyurethane, a polyether-based polyol having a more flexible skeleton is effective. Furthermore, in consideration of the density of an ether group that coordinates with ions and contributes to ionic conductivity, an oxyalkylene having a repeating unit having 3 or less carbon atoms is more preferable. Specific examples thereof include a polyol having polyethylene oxide and polypropylene oxide and the like as a repeating unit.

The hydroxyl group equivalent of the polyol is not particularly limited, but the hydroxyl group equivalent is preferably 100 mgKOH/g or more and 500 mgKOH/g or less, and more preferably 100 mgKOH/g or more and 300 mgKOH/g or less because it affects the physical properties of the polyurethane particles and thus the performance of the ERF.

Examples of a material that can be used as an isocyanate as another main agent constituting the polyurethane particles 31 include toluene diisocyanate (TDI), diphenylmethane diisocyanate (MDI), polymeric MDI (pMDI), tolidine diisocyanate, naphthalene diisocyanate (NDI), xylylene diisocyanate (XDI), tetramethyl-m-xylylene diisocyanate, and dimethylbiphenyl diisocyanate (BPDI), hexamethylene diisocyanate (HDI), isophorone diisocyanate (IPDI), hydrogenated xylylene diisocyanate, and dicyclohexylmethane diisocyanate.

Furthermore, an adduct, an isocyanurate, a biuret, an uretdione, and a blocked isocyanate and the like which are modified isocyanates can also be used. Examples of the modified isocyanate include a TDI-based isocyanate, a MDI-based isocyanate, an HDI-based isocyanate, and an IPDI-based isocyanate. Each isocyanate has a modified product. The isocyanate is not limited to one type, and two or more types can also be used in combination.

Furthermore, the ratio of the hydroxyl group of the polyol and the hydroxyl group or amine of the chain extender to the isocyanate affects the glass transition point (T_{g}) of the polyurethane particles to be formed, and the ER effect is exhibited at a higher temperature as the T_{g} is higher. Therefore, in order to exhibit the temperature dependency of the ER effect suitable for the actual use environment of a cylinder device, it is necessary to optimize the ratio of the hydroxyl group of the polyol to the isocyanate.

In particular, in the present invention, the T_{g} is increased by applying the chain extender, whereby the ratio of the isocyanate is reduced, which makes it necessary to make the T_{g} equivalent to that of the conventional product to improve the temperature dependence of the ER effect. It is preferable to add an isocyanate containing isocyanate groups at a specific addition ratio of 0.7 to 1.5 times in terms of a hydroxyl group or amine equivalent ratio so that the isocyanate reacts with the hydroxyl group of the polyol and the hydroxyl group or amine of the chain extender to form almost all urethane bonds.

Even polyurethane particles composed of a material other than the above-described materials are within the scope of the present invention in an ERF containing polyurethane particles using a chain extender.

The kind of a metal ion contained in the polyurethane particles 31 is not particularly limited as long as the metal ion can be disposed inside the above-described particles and produces the ER effect, but at least one kind of alkali metal is desirably contained as a cation. In particular, lithium ions, sodium ions, and potassium ions and the like having a small ionic radius are more desirable. As the ionic radius is smaller, displacement responsiveness is higher when a voltage is applied. Alkaline earth metals and transition metals, particularly barium ions, magnesium ions, zinc ions, copper ions, cobalt ions, and chromium ions and the like are likely to be coordinated to a molecular chain in the inner layer of the particle and remain, which is desirable.

An anion is not limited, and acetate ions, sulfate ions, nitrate ions, phosphate ions, and halogen ions and the like can be used. Halogen ions are particularly preferable from the viewpoint of ease of dissociation. When the corrosion resistance of a wetted part is low, it is desirable to use an organic anion having low corrosiveness. However, a material applicable to the present invention is not limited to the above as long as the material can be included in the polyurethane particles 31 and is an ion that functions as the ERF.

Considering the responsiveness of the ER effect and the magnitude of the effect, the average particle size of the polyurethane particles 31 is preferably 0.1 μm or more and 10 μm or less from the viewpoint of the ease of movement of the particles and the increasing width of a viscosity. When the average particle size is less than 0.1 μm, the polyurethane particles 31 are aggregated, which cause deteriorated workability in manufacturing. When the average particle size is more than 10 μm, the displacement responsiveness is deteriorated. The average particle size of the polyurethane particles 31 is more preferably in a range of 3 μm or more and 7 μm or less.

The concentration of the polyurethane particles 31 in an ERF 300 is preferably 30% by mass or more and 70% by mass or less from the viewpoint of the magnitude of an electroviscous effect and a base viscosity. When the concentration of the polyurethane particles 31 is less than 30% by mass, a sufficient ER effect cannot be obtained. When the concentration is more than 70% by mass, the base viscosity increases, a viscosity increase rate during voltage application decreases, and the change width of the damping force of a cylinder device decreases. A more preferable concentration for exhibiting the ER effect is in a range of 40% by mass or more and 60% by mass or less.

The type of the fluid 30 is not particularly limited as long as the fluid 30 is a dispersion medium capable of dispersing the polyurethane particles 31. Specifically, silicone oils and mineral oils such as paraffin oils and naphthene oils can be employed. Since the viscosity of the fluid 30 contributes to the viscosity and displacement responsiveness of the ERF 300, the viscosity is preferably 50 mm²/s or less, and more preferably 10 mm²/s or less.

The material compositions (the polyol, the isocyanate, and the chain extender and the like) of the polyurethane particles 31 contained in the ERF can be identified by the following method. By identifying monomers obtained by decomposing the polyurethane particles 31 by pyrolysis GC/MS and 1H_NMR of a hydrolysate, the material compositions of the polyol, isocyanate, chain extender, and other additives constituting the polyurethane can be identified.

[Cylinder Device]

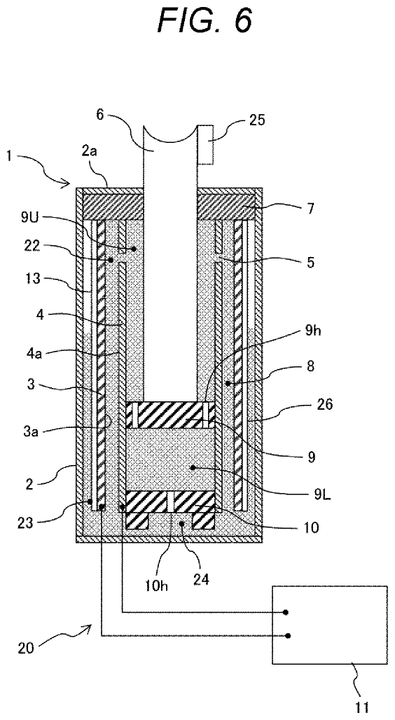

Next, the cylinder device of the present invention will be described. FIG. 6 is a schematic longitudinal cross-sectional view showing an example of the cylinder device of the present invention. A cylinder device 1 is usually provided one by one corresponding to each wheel of a vehicle, and mitigates impact and vibration generated between the body and the axle of the vehicle. In the cylinder device 1 shown in FIG. 1, a head provided at one end of a rod 6 is fixed to a body side of a vehicle (not illustrated), and the other end of the rod 6 is inserted into a base shell 2 and fixed to an axle side. The base shell 2 is a cylindrical member constituting an outer shell of the cylinder device 1, and an ERF 8 of the present invention described above is sealed in the base shell 2.

The cylinder device 1 includes, as main components, a rod 6, a piston 9 provided at the end part of the rod 6, an outer cylinder 3, an inner cylinder (cylinder) 4, and a voltage application device 20. The rod 6, the inner cylinder 4, the outer cylinder 3, and the base shell 2 are coaxially disposed.

As shown in FIG. 1, the rod 6 is provided with a piston 9 at an end part on a side to be inserted into the base shell 2. The voltage application device 20 includes an electrode (outer electrode 3a) provided on the inner peripheral surface of the outer cylinder 3, an electrode (inner electrode 4a) provided on the outer peripheral surface of the inner cylinder 4, and a control device 11 that applies a voltage between the outer electrode 3a and the inner electrode 4a.

The outer electrode 3a and the inner electrode 4a are in direct contact with the ERF 8. For this reason, it is desirable to adopt, as the material of the outer electrode 3a and the inner electrode 4a, a material that is less likely to cause electrolytic corrosion and corrosion due to the components contained in the ERF 8 described above. As the material of the outer electrode 3a and the inner electrode 4a, a steel pipe or the like can be used, but for example, a stainless pipe or a titanium pipe or the like can be desirably adopted. In addition, a metal film which is less likely to be corroded may be formed on the surface of a metal which is apt to be corroded by a plating treatment or formation of a resin layer or the like to improve corrosion resistance.

The rod 6 penetrates an upper end plate 2a of the inner cylinder 4, and the piston 9 provided at the lower end of the rod 6 is disposed in the inner cylinder 4. The upper end plate 2a of the base shell 2 is provided with an oil seal 7 that prevents the leakage of the ERF 8 sealed in the inner cylinder 4.

As the material of the oil seal 7, for example, a rubber material such as a nitrile rubber or a fluorine rubber can be adopted. The oil seal 7 is in direct contact with the ERF 8. Therefore, as the material of the oil seal 7, a material having a hardness equal to or higher than the hardness of the particles 28 contained in the ERF 8 is desirably adopted in order that the oil seal 7 is not damaged by the particles 28. In other words, as the particles 28 contained in the ERF 8, a material having a hardness equal to or lower than the hardness of the oil seal 7 is preferably adopted.

The piston 9 is vertically and slidably inserted into the inner cylinder 4. The inside of the inner cylinder 4 is partitioned into a piston lower chamber 9L and a piston upper chamber 9U by the piston 9. A plurality of through holes 9h vertically penetrating are circumferentially arranged at equal intervals in the piston 9. The piston lower chamber 9L and the piston upper chamber 9U are communicated with each other via the through hole 9h. The through hole 9h is provided with a check valve, and the ERF 8 flows in one direction through the through hole 9h.

An upper end part of the inner cylinder 4 is closed by the upper end plate 2a of the base shell 2 with the oil seal 7 interposed therebetween. A body 10 is provided at a lower end part of the inner cylinder 4. As with the piston 9, the body 10 has a through hole 10h, and is communicated with the piston lower chamber 9L via the through hole 10h.

In the vicinity of the upper end of the inner cylinder 4, a plurality of lateral pits 5 radially penetrating are circumferentially arranged at equal intervals. As with the inner cylinder 4, an upper end part of the outer cylinder 3 is closed by the upper end plate 2a of the base shell 2 with the oil seal 7 interposed therebetween. Meanwhile, a lower end part of the outer cylinder 3 is opened.

The lateral pit 5 communicates the piston upper chamber 9U defined by the inner side of the inner cylinder 4 and a rod portion of the rod 6 with a flow path 22 defined by the inner side of the outer cylinder 3 and the outer side of the inner cylinder 4. The flow path 22 communicates, at the lower end part, a flow path 23 defined by the inside of the base shell 2 and the outside of the outer cylinder 3 with a flow path 24 between the body 10 and a bottom plate of the base shell 2. The inside of the base shell 2 is filled with the ERF 8, and an upper part between the inside of the base shell 2 and the outside of the outer cylinder 3 is filled with an inert gas 13.

When the vehicle travels on an uneven traveling surface, the vibration of the vehicle causes the rod 6 to vertically expand and contracts along the inner cylinder 4. When the rod 6 expands and contracts along the inner cylinder 4, the volumes of the piston lower chamber 9L and the piston upper chamber 9U change.

A vehicle body (not illustrated) is provided with an acceleration sensor 25. The acceleration sensor 25 detects the acceleration of the vehicle body and outputs the detected signal to the control device 11. The control device 11 determines a voltage to be applied to an electroviscous fluid 8 based on a signal from the acceleration sensor 25 or the like.

The control device 11 calculates a voltage for generating a necessary damping force based on the detected acceleration, and applies a voltage between electrodes based on the calculation result, thereby exerting an electroviscous effect. When a voltage is applied by the control device 11, the viscosity of the ERF 8 changes according to the voltage. The control device 11 adjusts the applied voltage based on the acceleration to control the damping force of the cylinder device 1, thereby improving the ride comfort of the vehicle.

The cylinder device of the present invention uses the above-described ERF of the present invention, which makes it possible to achieve both a high ER effect and high durability. Therefore, it is possible to provide a cylinder device having a small change in the damping force even after long-term use.

### EXAMPLES

Hereinafter, the present invention will be specifically described with reference to Examples and Comparative Examples, but the present invention is not limited to the following Examples at all.

### Preparation of ERFs of Examples 1 to 3

A method for preparing an ERF of Example 1 will be described below.

The ERF of Example 1 was prepared by the following procedure. A polyol solution to which an electrolyte was added was prepared. In a 250 mL sample bottle, 12 g of polyoxyethylene trimethylolpropane ether and 0.00090 g of lithium chloride were stirred at 65° C. overnight. Thereafter, 0.021 g of zinc chloride was added into the mixture, followed by further stirring for 1 hour. Furthermore, 1,4-butanediol (BD) as a chain extender and 0.033 g of 1,4-diazabicyclo[2,2,2]octane as a catalyst were added into the mixture, followed by further stirring at 65° C. for 1 hour. All stirring blades were used for stirring, and a stirring speed was set to 200 rpm.

Subsequently, a silicone oil solution as a fluid was prepared by the following procedure. In a 250 mL sample bottle, 15 g of polydimethylsiloxane and 0.22 g of an emulsifier (OF7747) were stirred at room temperature overnight using a magnetic stirrer.

Subsequently, 12 g of the polyol solution described above and 15 g of the silicone oil solution described above were stirred in a disperser to be emulsified. The peripheral speed of the stirring blade of the disperser was set to 25 m/s, and a stirring time was set to 30 seconds. After stirring, the mixture was cooled to a liquid temperature of 20° C. using a cooling device. Stirring and cooling conditions in the disperser used in Examples are all the same.

As a curing agent, a mixture of 2,4 toluene diisocyanate (TDI) and polymethylene polyphenylene polyisocyanate (polymeric MDI) was used in a total amount of 5.0 g. The curing agent was added dropwise into 0.50 g of the solution, and the solution was stirred and cooled in the disperser to be cured.

Furthermore, the curing agent was added dropwise into 1.1 g of the solution, and the solution was stirred and cooled in a disperser to be cured. This operation was repeated four times. Thereafter, the solution was transferred to a 50 mL sample bottle, heated and stirred at 65° C. for 3 hours, and cured to obtain an ERF of Example 1. A chain extender and a blending ratio of Example 1 are described in Table 1 below.

ERFs of Examples 2 and 3 were prepared in the same manner as in Example 1 except that the blending amount of 1,4-BD of Example 1 was changed. Chain extenders and blending ratios of Examples 1 and 3 are also described in Table 1 below.

### Preparation of ERFs of Examples 4 to 9

In Example 4, an ERF was prepared in the same manner as in Example 1 except that 1,5-pentanediol was added instead of 1,4-BD in Example 1, and the blending amount was changed so that the hydroxyl group equivalent was equalized. A chain extender and a blending ratio of Example 4 are also described in Table 1.

In Example 5, an ERF was prepared in the same manner as in Example 1 except that 1,6-hexanediol was added instead of 1,4-BD in Example 1, and the blending amount was changed so that the hydroxyl group equivalent was equalized. A chain extender and a blending ratio of Example 5 are also described in Table 1.

In Example 6, an ERF was prepared in the same manner as in Example 1 except that hydroquinone(2-hydroxyethyl ether) was added instead of 1,4-BD in Example 1, and the blending amount was changed so that the hydroxyl group equivalent was equalized. A chain extender and a blending ratio of Example 6 are also described in Table 1.

In Example 7, an ERF was prepared in the same manner as in Example 1 except that 1,4-cyclohexamethylene dimethanol was added instead of 1,4-BD in Example 1, and the blending amount was changed so that the hydroxyl group equivalent was equalized. A chain extender and a blending ratio of Example 7 are also described in Table 1.

In Example 8, an ERF was prepared in the same manner as in Example 1 except that 1,6-hexanediamine(1,6-HDA) was added instead of 1,4-BD in Example 1, and the blending amount was changed.

A chain extender and a blending ratio of Example 8 are also described in Table 1.

In Example 9, an ERF was prepared in the same manner as in Example 1 except that the blending amount of 1,6-HD in Example 5 was changed. A chain extender and a blending ratio of Example 9 are also described in Table 1.

### Preparation of Electroviscous Fluids of Examples 10 and 11

In Example 10, an ERF was prepared in the same manner as in Example 2 except that the amount of the curing agent in Example 2 was changed. Chain extenders and blending ratios of Examples 10 and 11 are also described in Table 1.

In Example 11, an ERF was prepared in the same manner as in Example 1 except that the polyol in Example 1 was replaced with polyoxypropylene trimethylolpropane ether. Chain extenders and blending ratios of Examples 10 and 11 are also described in Table 1.

In Table 1, the main agent “polyoxyethylene trimethylolpropane ether” (Examples 1 to 10 and Comparative Example) is a polymeric polyol having a repeating unit having 2 carbon atoms. In Table 1, the main agent “polyoxypropylene trimethylolpropane ether” is a polymeric polyol having a repeating unit having 3 carbon atoms. In Table 1, a value obtained by dividing the blending ratio (%) by 100 is a hydroxyl group equivalent ratio.

### Preparation of Electroviscous Fluid of Comparative Example

An ERF of Comparative Example was prepared in the same manner as in Example 1 except that no chain extender was added. The configuration of the ERF of Comparative Example is also described in Table 1 described below.

### [Evaluation of ERF]

The electroviscous effect (ER effect) and the glass transition point of each of Examples 1 to 9 and Comparative Example were evaluated under the following conditions. The glass transition point (T_{g}) of each of the prepared samples of Examples 1 to 9 and Comparative Example was measured using differential scanning calorimetry (DSC). As a measurement sample, the ERF of each of Examples and Comparative Example was used as a liquid. The measured glass transition point is described in Table 1 described later.

The electroviscous effect of each of Examples 1 to 9 and Comparative Example was measured by a rotational viscometer method using a rheometer (manufactured by Anton Paar, model: MCR502). Using a flat plate having a diameter of 25 mm, yield stress was measured under the conditions of a measurement temperature range: 20 to 70° C. (10° C. interval) and an applied electric field strength: 5 kV/mm. In this rheometer, a shear rate was calculated as ⅔×(ω×R)/H, and shear stress was calculated as 4/3×M/(π×R3). Note that ω is an angular velocity, R is a plate radius, H is an inter-plate distance, and M is a motor torque. As a result of the measurement, the shear stress had a maximum value with respect to the shear rate, and thus the maximum value was defined as the yield stress in the present invention. A temperature indicating the yield stress was used as an evaluation object for an index of temperature dependence.

The evaluation results of Examples 1 to 9 and Comparative Example are shown in Table 1.

TABLE 1

| | | | | | Peak | Glass |
|---|---|---|---|---|---|---|
| | | | Blending rate (%) | | temperature of | transition |
| | | | (hydroxyl group | Yield stress | yield stress | point |
| | Chain extender | Main agent | equivalent ratio) | (kPa) | (° C.) | (° C.) |
| Example 1 | 1,4-BD | Polyoxyethylene | 10 | 4.5 | 40 | −20.1 |
| Example 2 | | trimethylolpropane | 25 | 5.5 | 40 | −16.5 |
| Example 3 | | ether | 50 | 6.1 | 70 | −0.8 |
| Example 4 | 1,5-PD | | 25 | 4.9 | 40 | −17.7 |
| | | | | 6.0 | 30 | −15.7 |
| Example 5 | 1,6-HD | | | | | |
| Example 6 | Hydroquinone | | | 5.6 | 50 | −13.9 |
| | di(2-hydroxyethyl | | | | | |
| | ether) | | | | | |
| Example 7 | 1,4- | | | 4.6 | 40 | −18.9 |
| | cyclohexamethylene | | | | | |
| | dimethanol | | | | | |
| Example 8 | 1,6-HDA | | | 5.0 | 50 | −14.7 |
| Example 9 | 1,6-HD | | | | | |
| | | | 10 | 4.9 | 30 | −24.3 |
| Example 10 | 1,4-BD, weight | | 25 | 6.0 | 20 | −24.5 |
| | reduction of | | | | | |
| | Isocyanate | | | | | |
| Example 11 | 1,4-BD | Polyoxypropylene | | 5.2 | 40 | −19.7 |
| | | trimethylolpropane | | | | |
| | | ether | | | | |
| Comparative | No chain extender | Polyoxyethylene | — | 4.0 | 20 | −25.5 |
| example | | trimethylolpropane | | | | |
| | | ether | | | | |

As shown in Table 1, all of Examples 1 to 9 within the scope of the present invention exhibited an ER effect (yield stress): 4.5 kPa or more higher than that of Comparative Example.

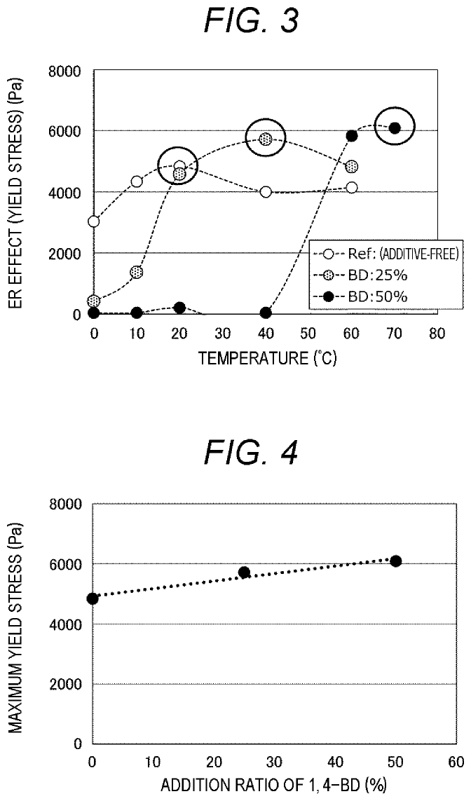

FIG. 3 is a graph showing the relationship between the yield stress of each of ERFs of Example 2, Example 3, and Comparative Example (Ref) and a temperature, and FIG. 4 is a graph showing the maximum yield stress of each of ERFs of Example 2, Example 3, and Comparative Example. As shown in FIGS. 3 and 4, it can be seen that the addition of the chain extender (BD) increases the yield stress as compared to the case of no addition. In FIG. 3, the peak temperature of the yield stress (temperature indicating the maximum yield force) moves to a high temperature side, but this temperature dependence can be adjusted by adjusting other components. Here, it is important that the maximum value of the yield stress is increased by the addition of the chain extender.

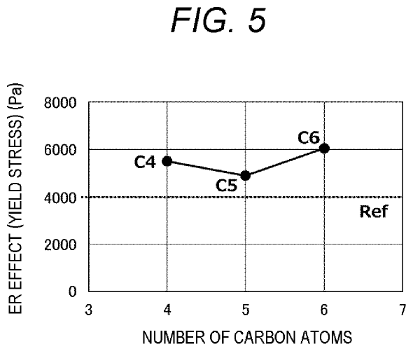

FIG. 5 is a graph showing the yield stress of each of ERFs of Example 2, Example 4, Example 5, and Comparative Example (Ref). As shown in FIG. 5, it can be seen that when a diol having an aliphatic skeleton is used as the chain extender, and the number of carbon atoms is even, an effect of increasing the yield stress is greater.

As described above, the present invention can provide an electroviscous fluid achieving both a large ER effect and durability, and a cylinder device.

The present invention is not limited to the above-described Examples, and various modifications are included in it.

For example, the above-described Examples are described in detail for convenience of explanation and good understanding of the present invention, and thus the present invention is not limited to one having all the described configurations. It is possible to replace a part of the configuration of certain Example with the configuration of another Example, and it is also possible to add the configuration of certain Example to the configuration of another Example. Further, regarding a part of the configuration of each Example, addition of another configuration, its deletion, and replacement with another configuration can be performed.

### REFERENCE SIGNS LIST

1 cylinder device
2 base shell
2a upper end plate
3 outer cylinder
3a outer electrode
4 inner cylinder (cylinder)
4a inner electrode
5 lateral pit
6 rod
7 oil seal
8 electroviscous fluid
9 piston
9L piston lower chamber
9U piston upper chamber
9h through hole
10 body
10h through hole
11 control device
13 inert gas
20 voltage application device
22, 23, 24 flow path
25 acceleration sensor
26 moisture absorbing mechanism
300 electroviscous fluid
30 fluid
31 polyurethane particles
40 soft segment
41 hard segment
42 ions

1. An electroviscous fluid comprising:
a fluid; and
polyurethane particles containing metal ions,
wherein the polyurethane particles have a phase separation structure of a hard segment and a soft segment, and contain an additive increasing a urethane bond forming the hard segment.

2. The electroviscous fluid according to claim 1, wherein the additive is a chain extender forming a polyurethane chain constituting the hard segment.

3. The electroviscous fluid according to claim 2, wherein the chain extender is a polyfunctional alcohol or a polyfunctional amine composed of a single molecule.

4. The electroviscous fluid according to claim 3,
wherein:
the polyurethane particles are composed of an isocyanate and a polyol which is a polymer having a repeating unit having 3 or less carbon atoms; and
an equivalence ratio of a hydroxyl group or an amino group to a hydroxyl group of the polyol of the polyfunctional alcohol or the polyfunctional amine: a substance amount of a hydroxyl group of the chain extender/a substance amount of the hydroxyl group or the amino group of the polyol is 0.11 or more.

5. The electroviscous fluid according to claim 3, wherein the polyfunctional alcohol or the polyfunctional amine includes at least an aliphatic diol or diamine.

6. The electroviscous fluid according to claim 5, wherein the diol or the diamine has an even number of carbon atoms.

7. The electroviscous fluid according to claim 5, wherein the diol is 1,4-butanediol or 1,6-hexanediol.

8. The electroviscous fluid according to claim 4, wherein the polyol contains a trifunctional polyol having three hydroxyl groups as a constituent component, and the polyurethane particles are made of a thermosetting resin in which thermal crosslinking occurs.

9. A cylinder device comprising:
a piston rod;
an inner cylinder into which the piston rod is inserted; and
an electroviscous fluid provided between the piston rod and the inner cylinder,
wherein the electroviscous fluid is the electroviscous fluid according to claim 1.
